(19) United States
(12) Patent Application Publication
(10) Pub. No.: US 2014/0355263 A1
(43) Pub. Date: Dec. 4, 2014

(54) LIGHTING APPARATUS

(71) Applicant: LITE-ON IT CORPORATION, Taipei (TW)

(72) Inventors: Hsueh-Fu LIAO, Hsinchu (TW); Chiang-Han LEE, Hsinchu (TW)

(73) Assignee: LITE-ON IT CORPORATION, Taipei (TW)

(21) Appl. No.: 14/155,837

(22) Filed: Jan. 15, 2014

(30) Foreign Application Priority Data
May 31, 2013 (TW) 102119282

(51) Int. Cl. F21V 14/08

(52) U.S. Cl. CPC F21V 14/08
USPC 362/231

(57) ABSTRACT

A lighting apparatus is provided. The lighting apparatus comprises a base, a light cover, at least a first light emitting element, and at least a second light emitting element. The light cover having an opening is disposed on the base and together with the base forms a holding space. The first light emitting element and the second light emitting element are disposed in the holding space. The wavelength of the light emitted from the first light emitting element is different from that emitted from the second light emitting element. The light cover is movable with respect to the first light emitting element. When the light cover is moved with respect to the first light emitting element, the light flux of the first light emitting element out of the light cover is changed.

This application claims the benefit of Taiwan application Serial No. 102119282, filed May 31, 2013, and the subject matter of which is incorporated herein by reference.

### BACKGROUND OF THE INVENTION

1. Field of the Invention

The invention relates in general to a lighting apparatus, and more particularly to a lighting apparatus with adjustable lighting characteristics.

2. Description of the Related Art

Light emitting diode (LED) bulb, having the characteristics of low power consumption and high brightness, has become more and more popular. However, most lamps (such as bulb lamps, projection lamps, and recessed lamps) have fixed color and color temperature, which are difficult to be adjusted. If a user has different requirements regarding the color and the color temperature, the user needs to replace the current lamp with a lamp having different color(s) and color temperature(s).

A commonly used method for adjusting the color or the color temperature employs several LEDs providing different color lights taken in conjunction with an IC element for controlling the intensity of the current of each LED. However, said method requires a large number of LEDs, and the IC element used for controlling electric signals incurs extra power consumption and material costs. Therefore, an effective solution is still unavailable.

### SUMMARY OF THE INVENTION

The disclosure is directed to a lighting apparatus. According to the lighting apparatus of the embodiments, the light flux of a light emitted by one of two light emitting elements out of the light cover can be adjusted by moving the light cover with respect to the two light emitting elements having different wavelengths, so as to change the ratio of the light fluxes of the lights emitted by the two light emitting elements out of the light cover and achieve the effect of adjusting the lighting characteristics of the lighting apparatus, such as color(s) or color temperature(s).

According to one embodiment of the present invention, a lighting apparatus is provided. The lighting apparatus comprises a base, a light cover and at least a first light emitting element and at least a second light emitting element. The light cover having an opening is disposed on the base and together with the base forms a holding space. The first light emitting element and the second light emitting element are disposed in the holding space. The wavelength of a light emitted from the first light emitting element is different from that emitted from the second light emitting element. The light cover is movable with respect to the first light emitting element. When the light cover is moved with respect to the first light emitting element, the light flux of the first light emitting element out of the light cover is changed.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A is an explosion diagram of a lighting apparatus according to an embodiment of the present disclosure.

FIG. 1B is a cross-sectional view of a lighting apparatus according to an embodiment of the present disclosure.

FIG. 2A is a 3D diagram of a lighting apparatus according to an embodiment of the present disclosure.

FIG. 2B-FIG. 2D are top views of a lighting apparatus according to an embodiment of the present disclosure.

FIG. 3A is an explosion diagram of a lighting apparatus according to another embodiment of the present disclosure.

FIG. 3B is a cross-sectional view of a lighting apparatus according to another embodiment of the present disclosure.

FIG. 4A is a 3D diagram of a lighting apparatus according to another embodiment of the present disclosure.

FIG. 4B-FIG. 4C are top views of a lighting apparatus according to another embodiment of the present disclosure.

### DETAILED DESCRIPTION OF THE INVENTION

According to the lighting apparatus of the present embodiment, the light flux of one of two light emitting elements out of the light cover can be adjusted by moving the light cover with respect to the two light emitting elements having different wavelengths, so as to change the ratio of the light fluxes of the two light emitting elements out of the light cover, and the effect of adjusting the lighting characteristics of the lighting apparatus, such as color(s) or color temperature(s), can thus be achieved. Detailed descriptions of the embodiments of the present disclosure are elaborated below with accompanying drawings. The identical or similar elements of the embodiments are designated with the same reference numerals. It should be noted that the accompanying drawings are simplified for the convenience of describing the embodiments of the disclosure, and detailed structures disclosed in the embodiments of the disclosure are for detailed descriptions only, not for limiting the scope of protection of the present disclosure. Anyone who is skilled in the technology field of the present disclosure can make necessary modifications or changes to these structures according to the needs in practical implementations.

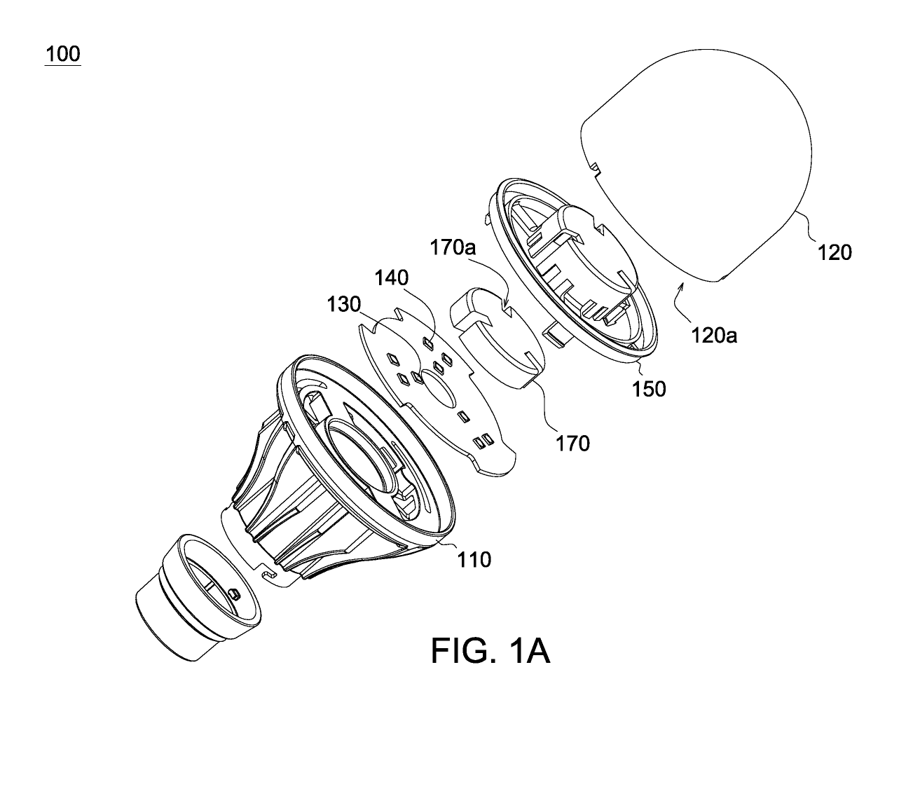

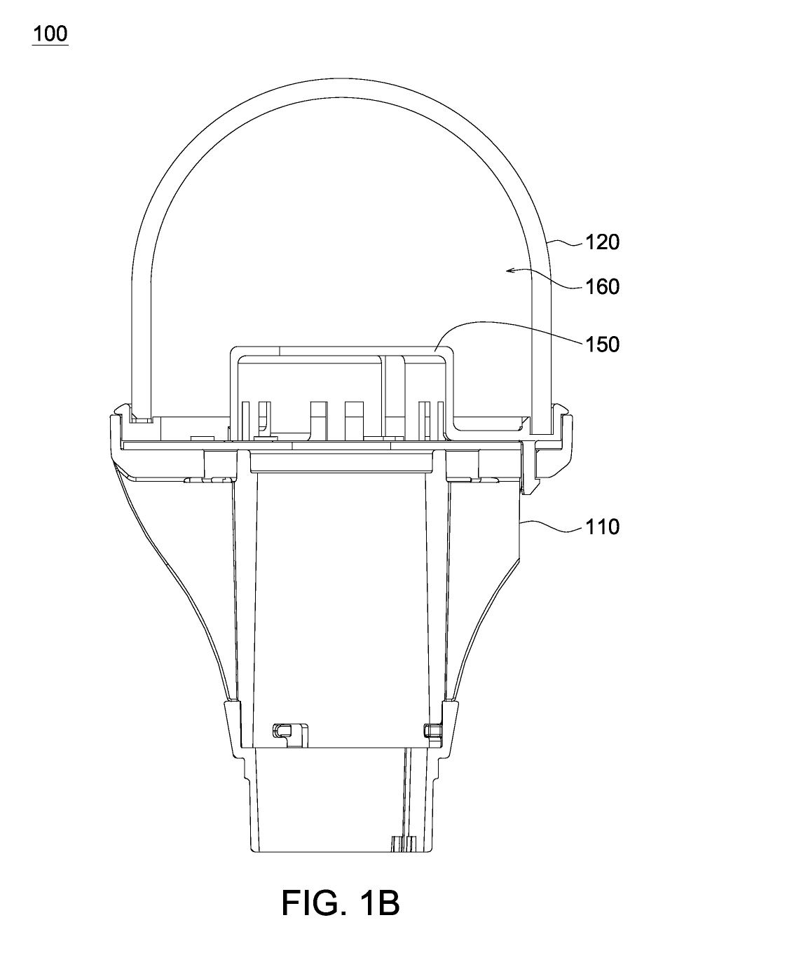

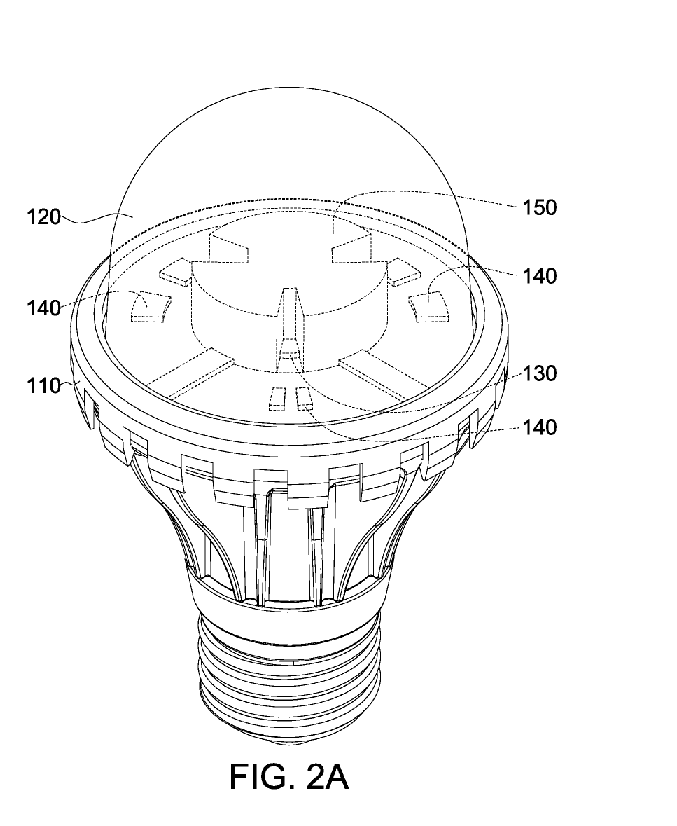

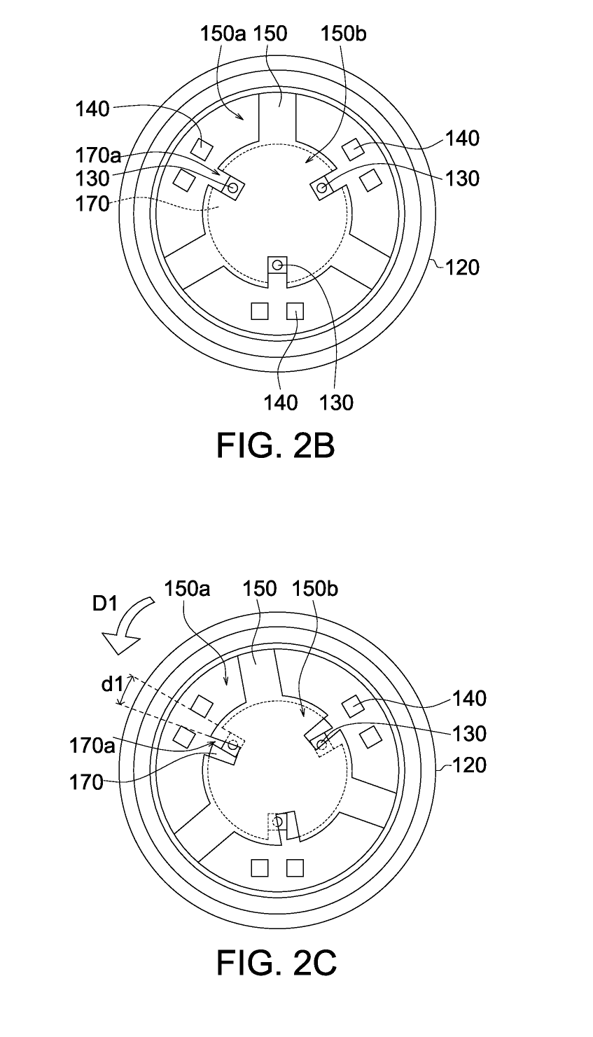

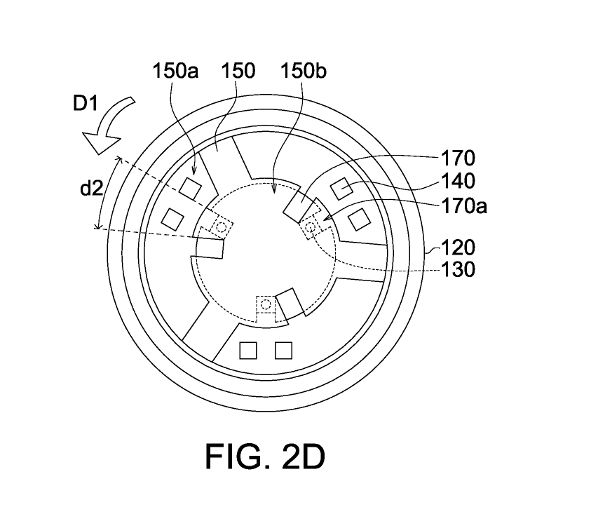

FIG. 1A is an explosion diagram of a lighting apparatus according to an embodiment of the present disclosure. FIG. 1B is a cross-sectional view of a lighting apparatus according to an embodiment of the present disclosure. FIG. 2A is a 3D diagram of a lighting apparatus according to an embodiment of the present disclosure. FIG. 2B-FIG. 2D are top views of a lighting apparatus according to an embodiment of the present disclosure.

Referring to FIG. 1A-FIG. 1B and FIG. 2A-FIG. 2D, the lighting apparatus 100 comprises a base 110, a light cover 120, at least a first light emitting element 130 and at least a second light emitting element 140. The light cover 120 has an opening 120a. The light cover 120 is disposed on the base 110, and together with the base 110 forms a holding space 160. The first light emitting element 130 and the second light emitting element 140 are disposed in the holding space 160. The wavelength of the light emitted from the first light emitting element 130 is different from the wavelength of the light emitted from the second light emitting element 140. The light cover 120 is movable with respect to the first light emitting element 130. When a relative position of the light cover 120 with respect to the first light emitting element 130 changes, the light flux of the first light emitting element 130 out of the light cover 120 is increased or decreased relatively.

In the present embodiment, when the light cover 120 is moved with respect to the first light emitting element 130, the light flux of the second light emitting element 140 out of the light cover 120 maintains constant. In other words, the light flux of the second light emitting element 140 out of the light cover 120 is not affected by the movement of the light cover 120. When the light cover 120 is moved with respect to the first light emitting element 130, the light flux of the first light emitting element 130 out of the light cover 120 is changed, while the light flux of the second light emitting element 140 out of the light cover 120 remains unchanged. Therefore, by changing the relative position of the light cover 120 with respect to the first light emitting element 130, the light flux of the first light emitting element 130 out of the light cover 120 can be changed, so as to change the ratio of the light flux of the first light emitting element 130 out of the light cover 120 to the light flux of the second light emitting element 140 out of the light cover 120 accordingly.

In an embodiment, the relative position between the first light emitting element 130 and the second light emitting element 140 is fixed. That is, when the light cover 120 is moved with respect to the first light emitting element 130, the light cover 120 is also moved with respect to the second light emitting element 140.

In the present embodiment, the wavelength of the light emitted from the first light emitting element 130 is different from that emitted from the second light emitting element 140. The wavelength of a light obtained by mixing the lights emitted from the light emitting elements 130 and 140 is different from the wavelengths of the lights emitted from the light emitting elements 130 and 140, and the lighting characteristics of the mixed light, such as the color or the color temperature, are also different from that of the lights emitted from the light emitting elements 130 and 140. When the ratio of the light flux of the first light emitting element 130 out of the light cover 120 to that of the second light emitting element 140 out of the light cover 120 is changed, the color or the color temperature of the mixed light out of the light cover 120 will be changed accordingly. Therefore, by moving the light cover 120, the light flux of the first light emitting element 130 out of the light cover 120 will be changed, and the lighting characteristics of the lighting apparatus 100, such as color(s) or color temperature(s), will also be changed accordingly.

In the present embodiment, as indicated in FIG. 2A-FIG. 2D, the lighting apparatus 100 may further comprise a light blocking structure 150 fixed on the light cover 120. The light cover 120 together with the light blocking structure 150 is movable with respect to the first light emitting element 130. When a relative position of the light blocking structure 150 with respect to the first light emitting element 130 is changed, an output area of the first light emitting element 130 blocked by the light blocking structure 150 is increased or decreased, so that the light flux of the first light emitting element 130 out of the light cover 120 is decreased or increased accordingly.

In the present embodiment, when the light cover 120 is moved with respect to the first light emitting element 130, the second light emitting element 140 is not blocked by the light blocking structure 150, so that the light flux of the second light emitting element 140 out of the light cover 120 maintains constant. According to the present embodiment, when the light cover 120 is moved with respect to the first light emitting element 130, the light flux of the first light emitting element 130 out of the light cover 120 is changed, because the first light emitting element 130 is blocked by the light blocking structure 150, while the light flux of the second light emitting element 140 out of the light cover 120 remains unchanged. Consequentially, the ratio of the light flux of first light emitting element 130 out of the light cover 120 to that of the second light emitting element 140 out of the light cover 120 is changed, and the color or the color temperature of the mixed light out of the light cover 20 is changed accordingly. Therefore, by moving the light cover 120 together with the light blocking structure 150, the light flux of the first light emitting element 130 out of the light cover 120 is changed, and the lighting characteristics of the lighting apparatus 100, such as color(s) and color temperature(s), is changed accordingly.

In the present embodiment, as indicated in FIG. 1A, the lighting apparatus 100 may further comprise a light converging structure 170 disposed between the first light emitting element 130 and the light blocking structure 150, and the relative position of the light converging structure 170 with respect to the first light emitting element 130 remains unchanged. As indicated in FIG. 1A, the light converging structure 170 may be disposed in the light blocking structure 150. The light converging structure 170 is made of the opaque material and has at least an indentation 170a which constantly corresponds to the first light emitting element 130, so that the light emitted from the first light emitting element 130 is more converged by passing through the indentation 170a.

In the present embodiment, as indicated in FIG. 2A-FIG. 2D, the light blocking structure 150 have a light-transmitting region 150a and a light blocking region 150b. When the light cover 120 together with the light blocking structure 150 is moved with respect to the first light emitting element 130, the output area of the first light emitting element 130 blocked by the light blocking region 150b is increased or decreased accordingly, and the second light emitting element 140 remains corresponding to the light-transmitting region 150a.

For example, as indicated in FIG. 2A-FIG. 2B, the first light emitting element 130 and the second light emitting element 140 both correspond to the light-transmitting region 150a. Meanwhile, the ratio of the light flux of the first light emitting element 130 out of the light cover 120 to the light flux of the light second emitting element 140 out of the light cover 120 is such as 1:1. As indicated in FIG. 2C, when the light cover 120 together with the light blocking structure 150 is moved with respect to the first light emitting element 130 for a distance d1 (such as along a counterclockwise direction D1), about 50% of the output area of the first light emitting element 130 is blocked by the light blocking region 150b, and the remaining output area, which is about 50% of the initial total output area, of the first light emitting element 130 corresponds to the light-transmitting region 150a. Meanwhile, the second light emitting element 140 still completely corresponds to the light-transmitting region 150a, so that the ratio of the light flux of the first light emitting element 130 out of the light cover 120 to the light flux of the second light emitting element 140 out of the light cover 120 is changed to such as 0.5:1. Moreover, as indicated in FIG. 2D, when the light cover 120 together with the light blocking structure 150 is moved with respect to the first light emitting element 130 for a distance d2 (such as along the counterclockwise direction D1), the output area of the first light emitting element 130 is completely blocked by the light blocking region 150b, and the light emitted from the first light emitting element 130 cannot penetrate the light-transmitting region 150a at all. Meanwhile, the second light emitting element 140 still completely corresponds to the light-transmitting region 150a, so that the ratio of the light flux of the first light emitting element 130 out of the light cover 120 to the light flux of the second light emitting element 140 out of the light cover 120 is changed to such as 0:1. As disclosed above, as the ratio of the light flux of the first light emitting element 130 out of the light cover 120 to that of the second light emitting element 140 out of the light cover 120 varies, the color or the color temperature of the mixed light out of the light cover 120 varies accordingly. Therefore, by changing the relative positions of the light cover 120 together with the light blocking structure 150 with respect to the first light emitting element 130, the lighting characteristics of the lighting apparatus 100, such as color(s) or color temperature(s), is changed accordingly.

In the present embodiment, the light-transmitting region 150b may be an opening or a light-transmitting element.

In the present embodiment, the lighting characteristics of the lighting apparatus 100, such as color(s) or color temperature(s), can be changed by simply moving the light cover 120, on which the light blocking structure 150 is fixed, and installation of extra IC control elements are not required. The lighting apparatus 100 of the present embodiments has simple structure requiring no expensive parts; therefore, the cost for manufacturing the lighting apparatus 100 with adjustable lighting characteristics can be largely reduced.

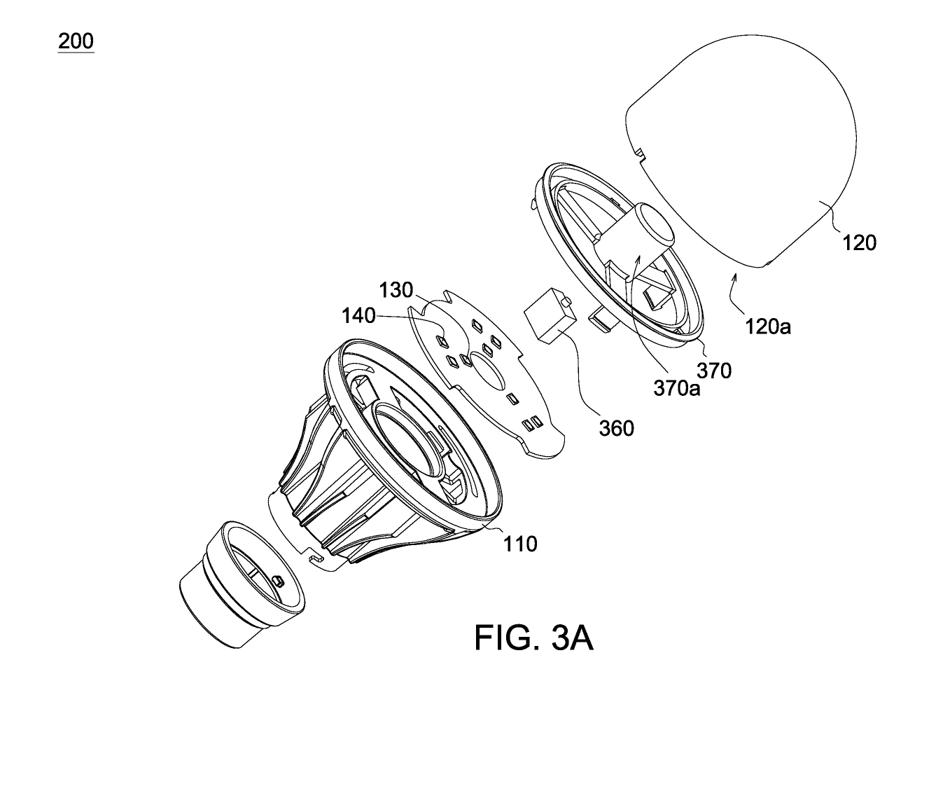

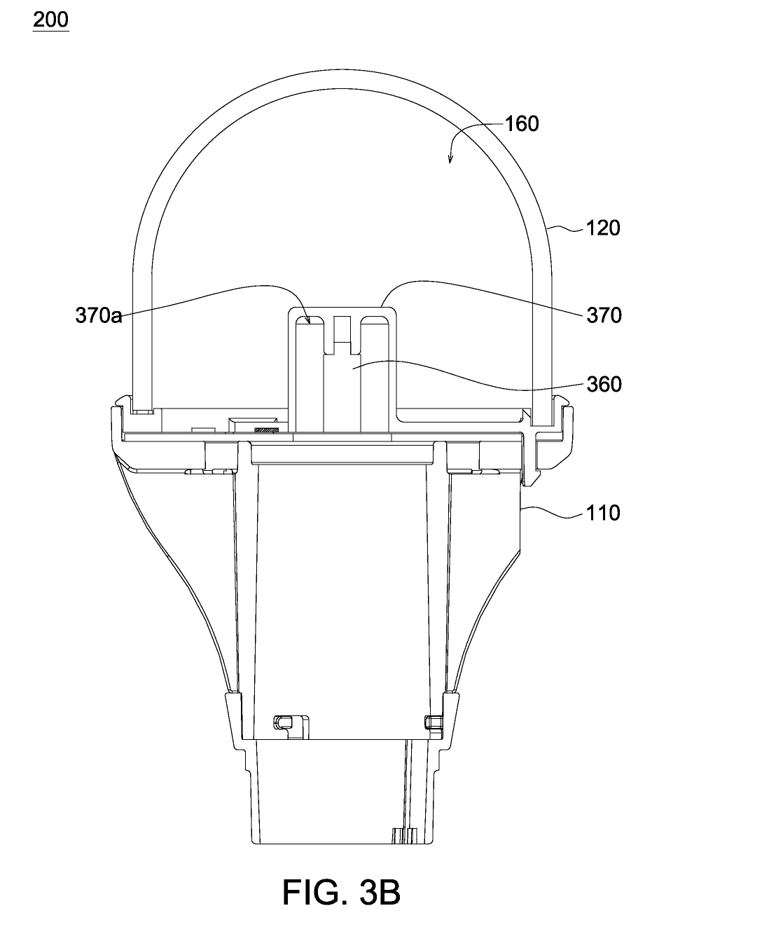

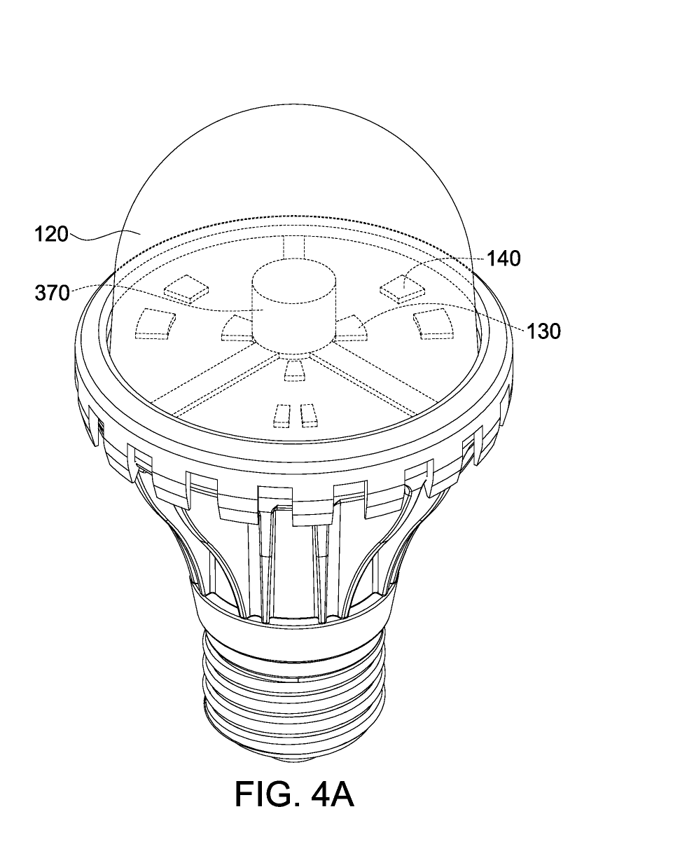

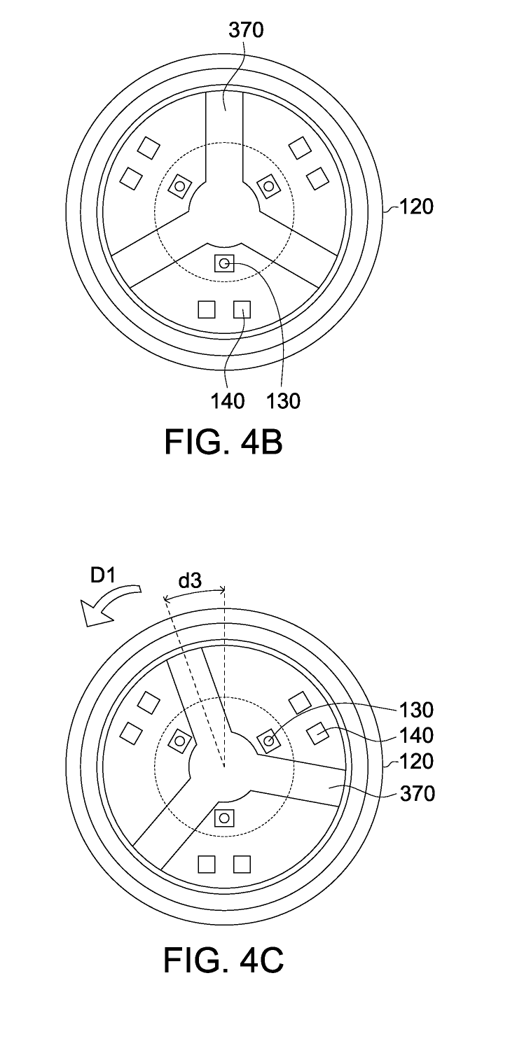

FIG. 3A is an explosion diagram of a lighting apparatus according to another embodiment of the present disclosure. FIG. 3B is a cross-sectional view of a lighting apparatus according to another embodiment of the present disclosure. FIG. 4A is a 3D diagram of a lighting apparatus according to another embodiment of the present disclosure. FIG. 4B-FIG. 4C are top views of a lighting apparatus according to another embodiment of the present disclosure.

Referring to FIG. 3A-FIG. 3B and FIG. 4A-FIG. 4C, the lighting apparatus 200 comprises a base 110, a light cover 120, at least a first light emitting element 130, and at least a second light emitting element 140. The light cover 120 is movable with respect to the first light emitting element 130. When the relative position of the light cover 120 with respect to the first light emitting element 130 is changed, the light flux of the first light emitting element 130 out of the light cover 120 is increased or decreased relatively. The lighting apparatus 200 of the present embodiment is different from the lighting apparatus 100 of the previous embodiment in that the light blocking structure 150 is replaced with an adjustable resistor element 360. The identical elements of the embodiments are designated with the same reference numerals, and the details are not repeated here for simplicity.

In the present embodiment, as indicated in FIG. 3A-FIG. 3B and FIG. 4A-FIG. 4C, the lighting apparatus 200 further comprises an adjustable resistor element 360 electrically connected to the first light emitting element 130. When the relative position of the light cover 120 with respect to the first light emitting element 130 is changed, the resistance of the adjustable resistor element 360 is increased or decreased, and the light intensity of the first light emitting element 130 is correspondingly decreased or increased. In the present embodiment, the adjustable resistor element 360 is disposed in the holding space 160 formed from the light cover 120 and the base 110.

In the present embodiment, the second light emitting element 140 is not electrically connected to the adjustable resistor element 360. When the light cover 120 is moved with respect to the first light emitting element 130, the light intensity of the second light emitting element 140 is not affected by the change of the resistance of the adjustable resistor element 360; accordingly, the light intensity of the second light emitting element 140 maintains constant. Therefore, the light flux of the second light emitting element 140 out of the light cover 120 maintains constant. In the present embodiment, when the light cover 120 is moved with respect to the first light emitting element 130, the light intensity of the first light emitting element 130 is changed due to the increase/decrease of the resistance of the adjustable resistor element 360, making the light flux of the first light emitting element 130 out of the light cover 120 changed accordingly. Since the light flux of the second light emitting element 140 out of the light cover 120 maintains constant, the ratio of the light flux of the first light emitting element 130 out of the light cover 120 to the light flux of the second light emitting element 140 out of the light cover 120 will be changed, and so will the color or the color temperature of the mixed light out of the light cover 120 be changed accordingly. Therefore, by moving the light cover 120 to change the resistance of the adjustable resistor element 360 and accordingly change the light flux of the first light emitting element 130 out of the light cover 120, the lighting characteristics of the lighting apparatus 100, such as color(s) or color temperature(s), will be changed.

In the present embodiment, as indicated in FIG. 3A-FIG. 3B and FIG. 4A-FIG. 4C, the lighting apparatus 200 may further comprise a moving structure 370 fixed on the light cover 120. The light cover 120 together with the moving structure 370 is movable with respect to the first light emitting element 130. The moving structure 370 is connected to the adjustable resistor element 360.

In the present embodiment, the moving structure 370 has a chamber 370a. The adjustable resistor element 360 is disposed in the chamber 370a and connected to the moving structure 370. When the moving structure 370 is moved with respect to the first light emitting element 130, the resistance of the adjustable resistor element 360 is changed accordingly.

For example, assuming that the resistance of the adjustable resistor element 360 is equal to 1 when the light cover 120 and the moving structure 370 are located at the positions as indicated in FIG. 4A and FIG. 4B; meanwhile, the ratio of the light flux of the first light emitting element 130 out of the light cover 120 to the light flux of the second light emitting element 140 out of the light cover 120 is such as 1:1. As indicated in FIG. 4C, when the light cover 120 together with the moving structure 370 is moved with respect to the first light emitting element 130 for a distance d3 (such as along the counterclockwise direction D1), the resistance of the adjustable resistor element 360 is increased to such as 2. Meanwhile, the light intensity of the first light emitting element 130 drops, and the ratio of the light flux of the first light emitting element 130 out of the light cover 120 to the light flux of the second light emitting element 140 out of the light cover 120 changes to such as 0.5:1. As disclosed above, when the ratio of the light flux of the light emitting element 130 out of the light cover 120 to that of the light emitting element 140 out of the light cover 120 changes, the color or the color temperature of the mixed light out of the light cover 120 is changed accordingly. Therefore, by changing the relative positions of the light cover 120 together with the moving structure 370 with respect to the first light emitting element 130, the resistance of the adjustable resistor element 360 is changed, and the lighting characteristics of the lighting apparatus 200, such as color(s) or color temperature(s), can further be changed accordingly.

In the present embodiment, the adjustable resistor element 360 may be at least one of a pulse width modulation (PWM) controller, a voltage controller, or a current controller.

In the present embodiment, by simply disposing the adjustable resistor element 360 in the lighting apparatus 200, the lighting characteristics, such as color(s) or color temperature(s), of the lighting apparatus 200 can be changed by simply moving the light cover 120 for changing the resistance of the adjustable resistor element 360, without any installation of complicated IC components. In addition, the moving structure 370 is fixed on the light cover 120; accordingly, the moving structure 370 is moved along with the movement of the light cover 120, such that the resistance of the adjustable resistor element 360 can be changed through a simple action of moving the light cover 120. The lighting apparatus of the present embodiments has a simple structure requiring no expensive parts; hence the cost for manufacturing the lighting apparatus 200 with adjustable lighting characteristics can be largely reduced.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lighting apparatus, comprising:
a base;
a light cover having an opening, wherein the light cover is disposed on the base and together with the base forms a holding space; and
at least a first light emitting element and at least a second light emitting element both disposed in the holding space, wherein the wavelength of a light emitted from the first light emitting element is different from the wavelength of a light emitted from the second light emitting element;
wherein the light cover is movable with respect to the first light emitting element, and when the light cover is moved with respect to the first light emitting element, the light flux of the first light emitting element out of the light cover is changed.

2. The lighting apparatus according to claim 1, wherein when the light cover is moved with respect to the first light emitting element, the light flux of the second light emitting element out of the light cover maintains constant.

3. The lighting apparatus according to claim 1, further comprising a light blocking structure fixed on the light cover, wherein the light cover together with the light blocking structure is movable with respect to the first light emitting element, and when the light blocking structure is moved with respect to the first light emitting element, an output area of the first light emitting element blocked by the light blocking structure is changed accordingly.

4. The lighting apparatus according to claim 3, wherein the light blocking structure has a light-transmitting region and a light blocking region, and when the light blocking structure is moved with respect to the first light emitting element, the second light emitting element remains corresponding to the light-transmitting region.

5. The lighting apparatus according to claim 4, wherein the light-transmitting region is an opening or a light-transmitting element.

6. The lighting apparatus according to claim 4, wherein when the light cover together with the light blocking structure is moved with respect to the first light emitting element, the output area of the first light emitting element blocked by the light blocking region is changed accordingly.

7. The lighting apparatus according to claim 3, further comprising a light converging structure disposed between the first light emitting element and the light blocking structure, wherein a relative position of the light collecting structure with respect to the first light emitting element remains unchanged.

8. The lighting apparatus according to claim 7, wherein the light converging structure has at least an indentation constantly corresponding to the first light emitting element.

9. The lighting apparatus according to claim 1, further comprising a adjustable resistor element electrically connected to the first light emitting element, wherein when the light cover is moved with respect to the first light emitting element, the adjustable resistor element has a resistance changed accordingly for changing the light intensity of the first light emitting element.

10. The lighting apparatus according to claim 9, further comprising a moving structure fixed on the light cover, wherein the light cover together with the moving structure is movable with respect to the first light emitting element, and the moving structure is connected to the adjustable resistor element.

11. The lighting apparatus according to claim 9, wherein the adjustable resistor element is a pulse width modulation (PWM) controller, a voltage controller or a current controller.
